(19) United States
(12) Patent Application Publication
(10) Pub. No.: US 2004/0117556 A1
(43) Pub. Date: Jun. 17, 2004

(54) Dynamic pipelining and prefetching memory data

(76) Inventor: Zafer Kadi, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/318,447

(22) Filed: Dec. 13, 2002

(51) Int. Cl. G06F 12/00

(52) U.S. Cl. 711/137; 711/103

(57) ABSTRACT

A method and apparatus to selectively pipeline and prefetch memory data, such as executable data, in one embodiment, using prefetch/pipeline logic that may prefetch and dynamically update a M number of prefetch bits (MP bits).

### BACKGROUND

This invention relates generally to storage and retrieval of memory data, and more particularly to pipelining and prefetching of executable memory data associated with various storage locations.

In portable environments or otherwise, many processor-based devices, such as consumer devices may include a semiconductor nonvolatile memory for erasably and programmably storing and retrieving information that may be accessed. One type of commonly available and used semiconductor nonvolatile memory is a flash memory. To operate a consumer device, a mix of code and data may be used in applications, especially in context-driven applications. For instance, a variety of wireless devices including cellular phones may include a flash memory to store different data files and resident applications. Likewise, a portable device, e.g., a personal digital assistant (PDA) may incorporate a flash memory for storing, among other things, certain operating system files and configurable data. As on example, flash memory executable data associated with instructions executing application programs may be stored and retrieved via a resident file management system. Typically, these instructions are accessed in sequence rather than randomly as is data.

One of the concerns regarding storage and retrieval of memory data involves memory latencies. Power and bandwidth consumption and portability of instructions across platforms or standards is another significant concern, particularly for wireless devices. While accessing instructions, a myriad of techniques including prefetching or pipelining has been deployed to reduce memory latencies. However, the memory latencies have not improved as fast as the operating frequency of microprocessors in processor-based devices. Moreover, conventional methods used for prefetching or pipelining are either static—sequentially prefetching or pipelining cache lines, decreasing the memory latencies at the expense of power or bandwidth consumption, or require additional complex silicon, again increasing power consumption. Other approaches have involved alteration of instruction code to accommodate special no operation (NOP) instructions, making the instruction code unportable across platforms and/or standards.

Thus, there is a continuing need for better ways to store and retrieve memory data.

### BRIEF DESCRIPTION OF THE DRAWINGS

FIG. 1 is a flowchart illustrating an embodiment of a method in accordance with the claimed subject matter.

FIG. 2 is a schematic diagram illustrating an embodiment in accordance with the claimed subject matter.

FIG. 3 is a schematic diagram illustrating an embodiment in accordance with the claimed subject matter.

FIG. 4A is a schematic diagram illustrating an embodiment in accordance with the claimed subject matter.

FIGS. 4B and 4C are schematic diagrams of one embodiment of FIG. 4A in accordance with the claimed subject matter.

FIG. 5 is a block diagram illustrating a communication device in accordance with the claimed subject matter.

FIG. 6 is a block diagram illustrating a computing device in accordance with the claimed subject matter.

### DETAILED DESCRIPTION

Although the scope of the claimed subject matter is not limited in this respect, it is noted that some embodiments may include subject matter from the following co-pending application: a patent application with a serial number of ______, and with a Title of “SELECTIVELY PIPELINING AND PREFETCHING MEMORY DATA”, attorney docket P14788 and with the inventor, Zafer Kadi.

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to reducing power consumption and/or improving bandwidth performance of memory for a variety of applications, such as, wireless, computing, and communication. As previously described, the present solutions either increase power consumption, increase software complexity, or sacrifice power and bandwidth consumption to decrease memory latencies. The number of consecutive instructions that are needed vary with the type of application. For example, multimedia applications typically require several consecutive cache lines while protocol stack code, such as wideband code-division multiple access (WCDMA) require only a few consecutive cache lines. Thus, a need exists to improve bandwidth performance without increasing power consumption or software complexity and to support the various types of applications

The claimed subject matter depicts a method, apparatus, and system for storing and an optional dynamic protocol for changing a “M” number of P prefetch bits (MP bits, hereinafter) in front of each memory line that contains information on whether the next memory line will be pre-fetched or pipelined. To illustrate, the pre-fetching and/or pipelining continues for a consecutive line if the number of MP bits are less than a predetermined threshold. Likewise, the claimed subject matter may be incorporated in a flash memory and/or a flash memory and a memory controller. Therefore, the invention facilitates a flash memory to store information that is dynamically updated and collected based on a usage profile. Alternatively, a dynamic random access memory, such as SDRAM, may also store the information that is copied from a Flash memory. In one embodiment, the prefetch may occur for one bit, designated as a Pbit in the previously filed P14788 application. Furthermore, this application discusses pre-fetching more than one bit, designated as a M number of P bits.

The claimed subject matter offers a variety of independent advantages, such as, the ability for increasing the ability to store more speculative pre-fetching with multiple bits, a more efficient memory controller interface by substantially decreasing and/or eliminating the pre-fetch latencies between a flash memory and a memory controller, usage profile optimization of embedded devices, dynamically collecting and updating information based on successful pre-fetch requests, improving XiP (execute in place) performance, and an interaction to allow software and hardware to store static and dynamic usage profile information for improving performance.

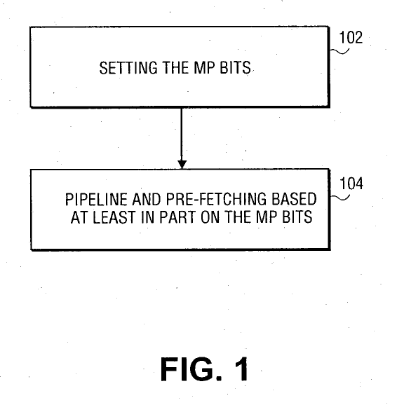

FIG. 1 is a flowchart illustrating an embodiment of a method in accordance with the claimed subject matter. This particular flowchart comprises a plurality of blocks 102 and 104, although, of course, the claimed subject matter is not limited to the embodiment shown. For this embodiment, the flowchart depicts, a dynamic method of pre-fetching and pipelining for a flash memory based at least in part on a plurality of MP bits.

In one embodiment, the block 102 facilitates the setting of the MP bits by pre-process and storing in a pipelining memory, such as, a flash memory or a DRAM via a flash memory. For example, either post-processing of instructions in a cache lines or a compiler are utilized to set the MP bits. Alternatively, a Bayesian logic is utilized to set a 50/50 threshold as a starting value for allowing dynamic updates to generate a correct usage profile. Subsequently, the block 102 also comprises setting an ON/OFF register or switch to any value, except zero or maximum (which is discussed in the next paragraph), based at least in part on a threshold. The maximum is based at least in part on a MP bit value. Thus, this results in storing code with the MP bits.

The logic to determine the amount of bits, if any, to prefetch is based on comparing a threshold value to a dynamic number of MP bits. For example, in one embodiment, the prefetching is disabled if the threshold value is set to a zero. In contrast, the prefetching is always enabled when the threshold value is set to a maximum value. Therefore, the threshold value is not set to either zero or the maximum. Rather, the threshold value is compared to the number of MP bits. If the threshold value is greater than the number of MP bits, then a prefetch analysis is performed. Otherwise, a prefetch is not performed.

As previously discussed, a prefetch analysis is performed when the threshold value is greater than the number of MP bits. If the current prefetch cache line is being used, then the number of MP bits is increased. Thus, the prefetch analysis allows for dynamic changes to the number of MP bits based at least in part on whether the prefetched line is used. Otherwise, the number of MP bits is decreased if the current prefetched cache line is not used. Of course, the amount of increase or decrease in the MP bits or threshold values may be different for each memory device or memory controller. Also, the prefetch logic and threshold values may be individually determined within an integrated device or embedded memory or may be based on a global setting for all devices.

Therefore, the claimed subject matter is flexible to allow for support of various applications by increasing or decreasing the number of MP bits. In some multi-media applications, a need exists for several consecutive cache lines and the number of prefetch bits could be increased. Alternatively, some applications only need one or two consecutive cache lines and the number of prefetch bits may be decreased. Therefore, in one aspect, the claimed subject matter increases performance by allowing for more prefetching when necessary. Alternatively, the claimed subject matter decreases power consumption by reducing the number of prefetched MP bits for applications that do not require additional pre-fetching.

The next block 104 pipelining and pre-fetching based at least in part on the MP bits. For example, in one embodiment, the pre-fetching is performed if the On/Off register or switch is set (as previously described in block 102); if there are no outstanding transactions, such as, no transactions in the address/transaction buffer (described in previous Figure); and if the MP bits is are high enough in value compared to the threshold and if the pre-fetch store buffer is able to store the pre-fetch data., then prefetch) Alternatively, a memory controller, coupled to the flash memory that can support multiple P bits, can store the pre-fetch data in the memory controller buffer. In contrast, for a Static multiple P bits, the logic for utilizing re-fetched lines from a data buffer could be incorporated into the memory controller.

Alternatively, the claimed subject matter facilitates dynamic setting of thresholds (for example, based on bus activity). Another embodiment is for improved behavior of the memory controller such as pushing the data into other components such as caches, or other devices (Graphics Controller) or memory (DRAM).

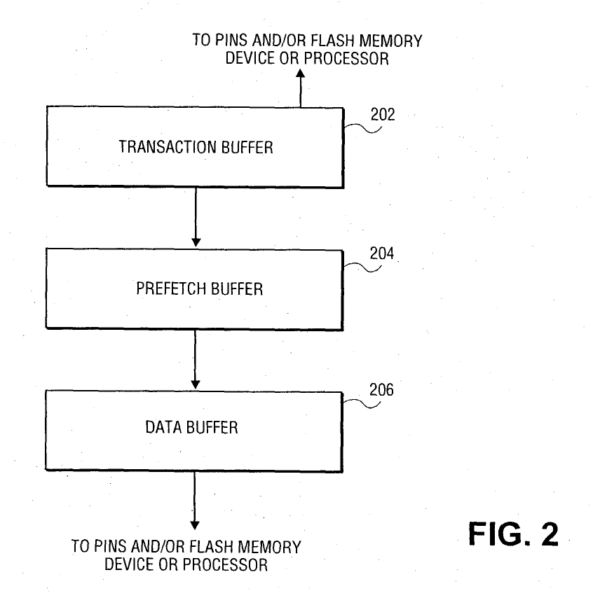

FIG. 2 is a schematic diagram illustrating an embodiment in accordance with the claimed subject matter. In one embodiment, the schematic is coupled to a flash memory device and/or a processor. In one embodiment, the schematic diagram receives an address from either a flash memory device or a processor and returns data based at least in part on the address. In the same embodiment, the schematic depicts a memory controller to support Static P-bits, thus, it does not support dynamic updates back to the flash memory device.

The schematic comprises a transaction buffer 202, logic for a pre-fetch buffer 204, a First In First Out (FiFO) or Last In First Out (LIFO) data buffer 206. The schematic responds to whether there is a pending request. If not, the data will be forward to the data buffer 206. Subsequently, the schematic responds to whether the requested data is in the pre-fetch buffer. If so, the data is retrieved from the data buffer. Otherwise, the request is forwarded to the transaction buffer.

In one embodiment, the data buffer 206 and the logic for the pre-fetch buffer may be incorporated within a memory controller. Alternatively, the data buffer and the logic for the pre-fetch buffer may be incorporated within a flash memory device.

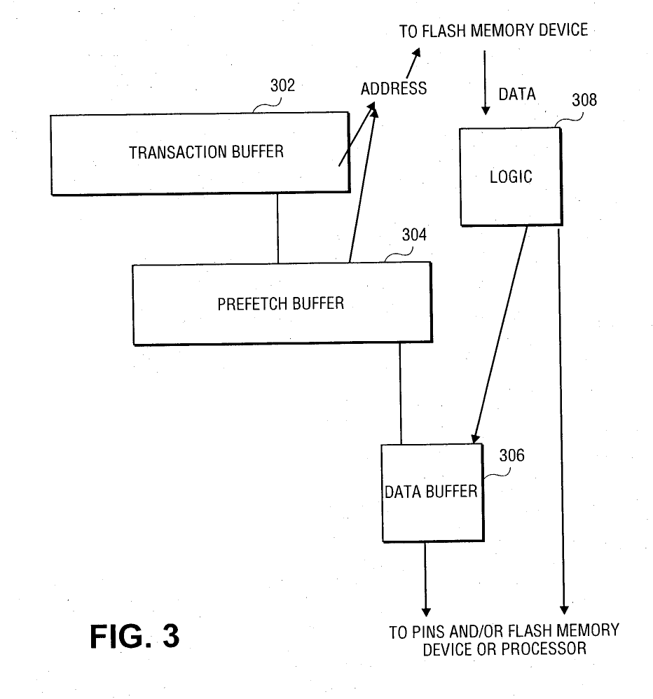

FIG. 3 is a schematic diagram illustrating an embodiment in accordance with the claimed subject matter. In one embodiment, the schematic is coupled to a flash memory device and/or a processor. In one embodiment, the schematic diagram receives an address from either a flash memory device or a processor and returns data based at least in part on the address. In the same embodiment, the schematic depicts a memory controller to supports dynamic MP-bits thus, it does support dynamic updates back to the flash memory device. A memory controller may facilitate the flash memory to transfer MP bits by either utilizing a user-defined protocol or dedicated pins. One skilled in the art appreciates modification of a protocol or pin configuration based on the particular implementation.

The schematic comprises a transaction buffer 302, a first logic for a pre-fetch buffer 304, a First In First Out (FiFO) or Last In First Out (LIFO) data buffer 306, and a second logic 308 that is coupled to the data buffer. The schematic receives data from the flash memory device and returns address information to the flash memory device. Subsequently, the second logic 308 determines whether there is a pending request. If not, the data will be forward to the data buffer 306. Subsequently, the first logic responds to whether the requested data is in the pre-fetch buffer. If so, the data is retrieved from the data buffer and the address associated with the data is forwarded to the flash memory device. Otherwise, the address of the request is forwarded to the flash device via the transaction buffer.

In one embodiment, the data buffer 306 and the logic for the pre-fetch buffer may be incorporated within a memory controller. Alternatively, the data buffer and the logic for the pre-fetch buffer may be incorporated within a flash memory device.

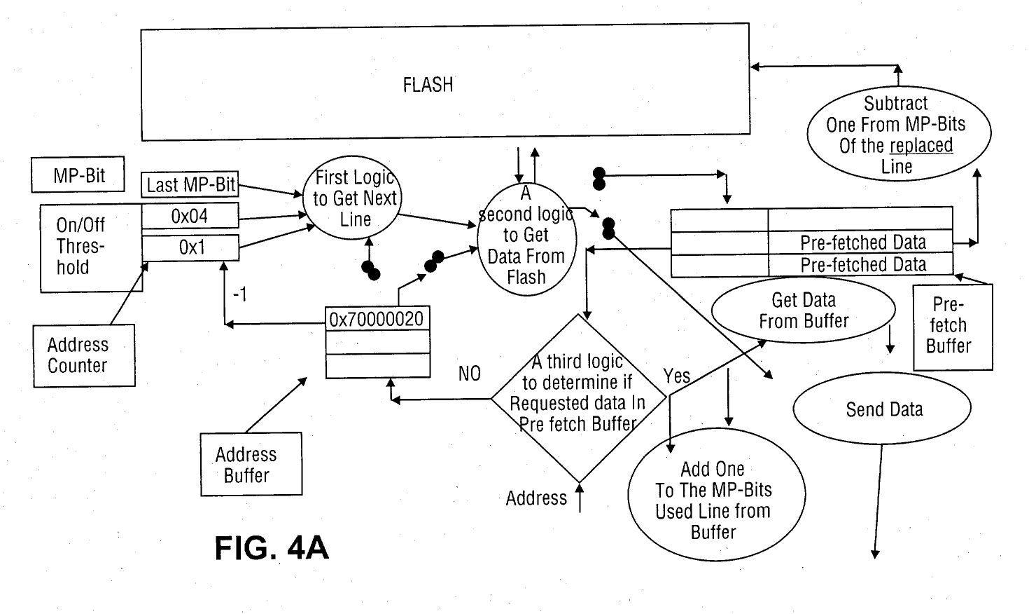

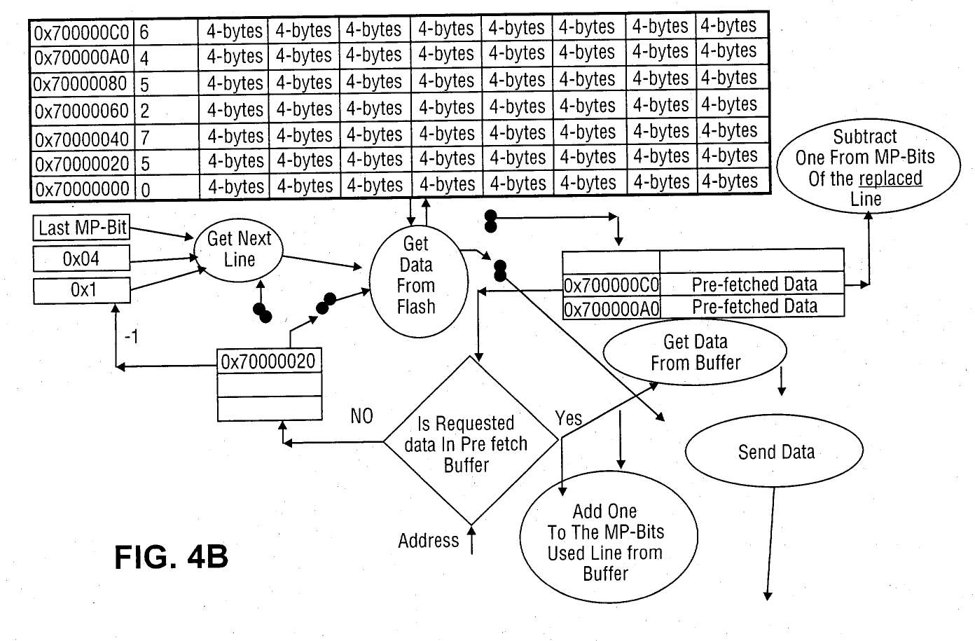

FIG. 4 is a schematic diagram illustrating an embodiment in accordance with the claimed subject matter. In one embodiment, the schematic diagram is coupled to a flash memory and is integrated within a memory controller. In another embodiment, the schematic diagram is integrated within a flash memory.

The schematic comprises a first logic coupled to a plurality of registers for storing an address counter, a threshold value, and a value of the last MP bit. Likewise, the schematic diagram comprises an address buffer and a prefetch buffer, coupled to a second logic and a third logic.

The address buffer comprises address(es) of a plurality of prefetched data stored in the prefetch buffer. As previously described, one register stores the threshold value to determine whether to prefetch and the value may be dynamically set by a memory controller. For example, a value of “ON” indicates to prefetch when possible. In contrast, a value of “OFF” indicates no prefetching. Finally, a value of a threshold (as previously described in connection with FIG. 1) allows for prefetching based on a variety of conditions. For example, the first logic determines whether to perform prefect for the next cache line. In one embodiment, the prefetch occurs for the next memory line when: prefetching is allowed (ON value) and either there are no outstanding transactions or the buffers are not full or the last transaction resulted in a miss condition.

A third logic determines if the requested data is in the prefetch buffer. If so, the threshold value is incremented. Otherwise, the threshold value is decremented. In one embodiment, the value is incremented by one for a hit and decremented by one for a miss. However, the claimed subject matter is not limited to this increment/decrement value. The amount of incrementing or decrementing threshold value may be based on a variety of conditions, such as, applications, user defined, size of memory line, etc. An example of this incrementing and decrementing will be discussed in connection with FIGS. 4B and 4C.

FIGS. 4B and 4C illustrate an example of one embodiment of FIG. 4A in accordance with the claimed subject matter. FIG. 4B illustrates a table at the top of the figure that comprises a plurality of rows to depict a cache line within a flash memory. For each row, reading from left to right, the row comprises an address, a MP bit value, and a plurality of bytes (4 bytes for one embodiment). In this example, the address buffer contains the address “0×70000020” and the prefetch buffer contains the addresses “0×700000C0” and “0×700000A0” and their corresponding data. FIG. 4C depicts subtracting one from the MP bits value of the replaced line “0×700000A0”, thus, resulting in a value of three (rather than the original 4 value depicted in FIG. 4B.

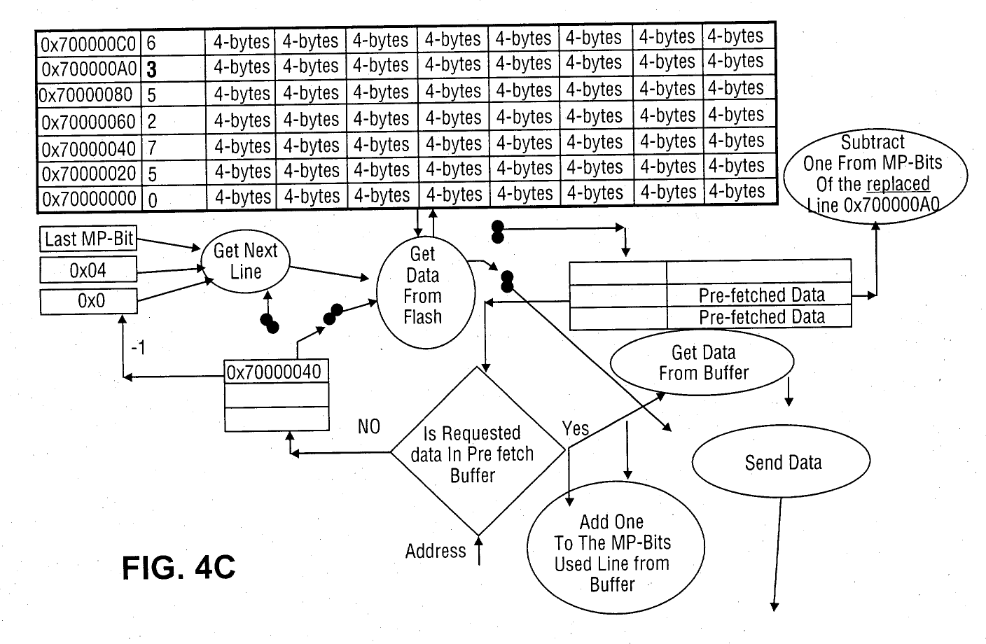

FIG. 5 is a block diagram illustrating a communication device in accordance with the claimed subject matter, and is similar to FIG. 4A depicted in previously filed application: a patent application with a serial number of, and with a Title of “SELECTIVELY PIPELINING AND PREFETCHING MEMORY DATA”, attorney docket P14788 and with the inventor, Zafer Kadi.

For example, in one embodiment, the communication device is a wireless communication device 250 that may comprise a wireless interface 255, a user interface 260, and an antenna 270 in addition to the components of a typical processor device 20. Although this particular embodiment is described in the context of wireless communications, other embodiments of the present invention may be used in any one of situations that involve storage and retrieval of memory data. Examples of the wireless communication device 250 include mobile devices and/or cellular handsets that may involve storage and/or retrieval of memory data provided over an air interface to the wireless communication device 250 in one embodiment. In any event, for executing the application 65 from the semiconductor nonvolatile memory 50, the wireless interface 255 may be operably coupled to the requester device 270 via the internal bus 45, exchanging network traffic under the control of the prefetch/pipeline logic 70.

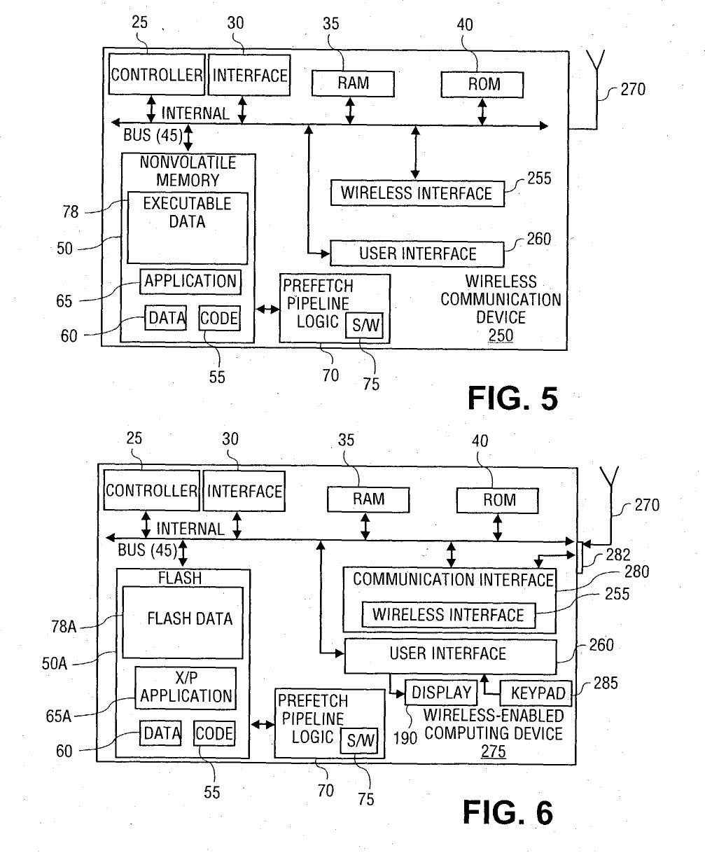

FIG. 6 is a block diagram illustrating a computing device in accordance with the claimed subject matter. FIG. 6 is similar to FIG. 4B depicted in a patent application with a serial number of ______, and with a Title of “SELECTIVELY PIPELINING AND PREFETCHING MEMORY DATA”, attorney docket P14788 and with the inventor, Zafer Kadi.

For example, in one embodiment, the computing device is a wireless-enabled computing device 275 that may comprise a communication interface 280 operably coupled to a communication port 282 that may communicate information to and from a flash memory 50a in accordance with one embodiment of the present invention. While a keypad 285 may be coupled to the user interface 260 to input information, a display 290 may output any information either entered into or received from the user interface 260. The wireless interface 255 may be integrated with the communication interface 280 which may receive or send any wireless or wireline data via the communication port 282. For a wireless communication, the requester device 270 may operate according to any suitable one or more network communication protocols capable of wirelessly transmitting and/or receiving voice, video, or data. Likewise, the communication port 282 may be adapted by the communication interface 280 to receive and/or transmit any wireline communications over a network.

Furthermore, within the flash memory 50a flash data 78a incorporating the executable data of an XIP application 65a may be stored along with the static data 60 in some embodiments of the present invention. The XIP application 65a may be advantageously executed from the flash memory 50b. Using the prefetch/pipeline logic 70, the wireless-enabled computing device 275 may be enabled for executing the XIP application 65a and other features using the flash memory 50a in some embodiments of the present invention. As an example, in one embodiment, mobile devices and/or cellular handsets may benefit from such a selective prefetch/pipeline technique based on the prefetch/pipeline logic 70, providing an ability to manage code, data, and files in the flash memory 50a. A flash management software may be used in real-time embedded applications in some embodiments as another example. This flash management software may provide support for applets, file transfers, and voice recognition. Using an application program interface (API) that supports storage and retrieval of data, based on the prefetch/pipeline logic 70, data streams for multimedia, Java applets and native code for direct execution, and packetized data downloads may be handled in some embodiments of the present invention.

Storage and retrieval of the executable data 78 ranging from native software compiled strictly for a processor in a system, to downloaded code, which is read and interpreted by a middleware application (such as an applet) may be obtained in one embodiment for the flash memory 50a. By selectively prefetching and/or pipelining a cache line's location address 74 in the flash memory 50a, XIP code execution may be enabled in some embodiments.

By combining of all semiconductor nonvolatile memory functions into a single chip, a combination of executable data and other static data may be obtained in a single flash memory chip for the flash memory 50a in other embodiments. In this manner, a system using an operating system (OS) may store and retrieve both the code 55 and the data 60, while the executable data 78 may be directly executed, demand paged, or memory mapped in some embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for prefetching for a memory line or lines of a memory comprising:
setting a M number of prefetch bits; and
prefetching the memory line based at least in part on the M number of prefetch bits.

2. The method of claim 1 wherein setting the M number of prefetch bits comprises either post-processing of instructions in the memory line or lines, optimum setting the M number of prefetch bits with a compiler or other means, or with a 50/50 Bayesian logic.

3. The method of claim 1 wherein prefetching the memory line comprises determining whether a On/Off value is not equal to a predetermined value or zero, determining whether an address buffer is empty, comparing the M number of pre-fetch bits to a threshold value, and determining whether there a prefetch buffer is full.

4. The method of claim 1 wherein the memory is a flash memory.

5. The method of claim 1 wherein the memory is a DRAM memory that stores data that is copied from a flash memory.

6. A method for prefetching for a memory line or lines of a memory comprising:
comparing a M number of prefetch bits to a threshold value; and
prefetching the M number of prefetch bits based at least in part on the result of the comparison.

7. The method of claim 6 wherein the M number of prefetch bits are increased if a current prefetched memory line is being used.

8. The method of claim 6 wherein the M number of prefetch bits is decreased if a current prefetched memory line is not being used.

9. The method of claim 6 further comprising dynamically updating the M number of prefetch bits based at least in part on the result of the comparison.

10. The method of claim 6 wherein the prefetching is disabled if the threshold value has a value of zero.

11. A memory controller, coupled to memory, to receive data from the memory and forward an address to the memory, comprising
a data buffer;
the memory controller to determine whether a plurality of requested data is stored within a prefetch buffer of the memory, if so, the data is retrieved from the data buffer and forwarded to the memory; and
the memory controller to support a static P bit mode of operation.

12. The memory controller of claim 11 to receive data from the memory in the absence of a pending request and to store the data in the data buffer.

13. The memory controller of claim 11 to forward the pending request to a transaction buffer of the memory if the plurality of requested data is not stored within the prefetch buffer of the memory.

14. The memory controller of claim 11 wherein the memory is a flash memory.

15. A memory controller, coupled to memory, to receive data from the memory and forward an address to the memory, comprising
a data buffer;
the memory controller to determine whether a plurality of requested data is stored within a prefetch buffer of the memory, if so, both the data is retrieved from the data buffer and the address associated with the data is forwarded to the memory; and
the memory controller to support a dynamic P bit mode of operation.

16. The memory controller of claim 15 to receive data from the memory in the absence of a pending request and to store the data in the data buffer.

17. The memory controller of claim 15 to forward the pending request to a transaction buffer of a memory device if the plurality of requested data is not stored within the prefetch buffer of the memory.

18. The memory controller of claim 15 wherein the memory is a flash memory.

19. An article comprising a medium storing instructions that, when executed result in:
comparing a M number of prefetch bits to a threshold value; and
prefetching the M number of prefetch bits based at least in part on the result of the comparison.

20. The article of claim 19, wherein the M number of prefetch bits is increased if a current prefetched memory line is being used.

21. The article of claim 19, wherein the M number of prefetch bits is decreased if a current prefetched memory line is not being used.

22. The article of claim 19, dynamically updating the M number of prefetch bits based at least in part on the result of the comparison.

23. The article of claim 19, wherein the prefetching is disabled if the threshold value has a value of zero.
